(19) United States
(12) Patent Application Publication
(10) Pub. No.: US 2004/0251207 A1
(43) Pub. Date: Dec. 16, 2004

(54) Method and apparatus for deionizing water

(76) Inventor: Robert Carlberg, Candia, NH (US)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/459,041

(22) Filed: Jun. 11, 2003

(51) Int. Cl. C02F 1/42

(52) U.S. Cl. 210/670; 210/681; 210/284

(57) ABSTRACT

A method and apparatus for producing deionized water by passing water to be treated through a deionizing and water treatment system having carbon filtration and beds of packed ion exchange resins, specifically including beds of mixed anion resins, so that sediment and impurity ions are removed as adsorbed on the ion exchange sites of the resins and a method of regenerating the ion exchange resins after having its ion-exchanging and adsorbing abilities lowered.

### FIELD OF THE INVENTION

The present invention relates to a method and apparatus for producing deionized water by passing source water to be treated through a deionizing and water treatment system having carbon filtration and beds of packed ion exchange resins, specifically including beds of mixed anion resins, so that sediment and impurity ions are removed as adsorbed on the ion exchange sites of the resins. The invention also relates to a method of regenerating the ion exchange resins after having its ion-exchanging and adsorbing abilities lowered.

### BACKGROUND OF THE INVENTION

As is known, many objects including automobiles, boats and homes are washed using readily available tap water from a conventional local utility or city source. Typically, tap water contains many dissolved organic and inorganic materials. The readily apparent problem in most cases where tap water is used to clean desired objects is that when tap water evaporates, after the washing and rinsing process, much of the dissolved organic and inorganic materials in the tap water remain on the surface of the object being cleaned. These unwanted materials are the main cause of what is known in the industry as spotting.

In addition, often times along with this use of tap water, soaps and/or detergents are used in the washing process. The use of soaps and/or detergents with tap water requires a tremendous amount of water to fully remove the soaps and/or detergents from the object being cleaned. Thus, the elimination of the soaps and detergents as well as organic and inorganic substances from the cleaning process eliminates the need for substantial amounts of water in the cleaning and rinsing process which can of course result in tremendous water savings.

By way of example, at a fixed car wash location the general water usage for washing a medium size passenger vehicle may be in the range of 125-300 gallons per vehicle, for truck washes, i.e., large commercial trucks, water usage for washing is in the range of about 200-300 gallons per vehicle.

It is known in the industry that by using deionized water in the washing process the problem of spotting and the need for over use of soaps and/or detergents may be minimized. However, deionized water as it is currently produced can still cause minor spotting, and perhaps more importantly, deionized water is often aggressive, in other words, deionized water often has a corrosive effect on the surface being washed, whether the surface is glass, plastic, clear coat finishes, chrome, stainless steel, fiberglass or rubber moldings. This is due to the fact that deionized water is often produced having remaining H⁺ ions thus causing the water to be somewhat acidic in nature and therefore particularly corrosive on many materials. Additionally, conventional mixed bed media for producing deionized water is not only very aggressive, but also the media for deionizing the water itself must be changed after washing somewhere in the range of 1,100-1,800 units.

### OBJECT AND SUMMARY OF THE INVENTION

It is therefore an object of the invention to provide an improved method and apparatus for producing deionized water that reduces the noted problems associated with conventional deionized water production systems.

Wherefore it is a further object of the invention to produce deionized water which accomplishes improved and superior cleaning without the need for soaps and/or detergents.

A still further object of the present invention is to enable a method of deionizing water which permits spot free air drying of various surfaces and is not aggressive or corrosive on the washed surface(s).

Another object of the invention is to provide for the economical and environmental benefits of providing tremendous cleaning power with less water usage, at least 50-75% less water than known processes, during the washing and rinsing procedure by providing a three bed, three stage media filtration process that removes the total dissolved solids found in most water supplies.

Another object of the invention is to provide a specific media in the three stage media filtration process that has different amounts and types of plastic or resin beads mixed together making the present invention kinder and less aggressive than known processes and which allows for an extended media life of at least 50-70% over conventional processes

A further object of the invention is a water filtration and deionization process comprising the steps of filtering water to be treated through a sediment filtration device, directing the water through an activated carbon bed, conducting the water to be treated through a strong acid cation resin bed, and directing the water to be treated through a mixed bed of a strong anion base resin and a weak anion base resin.

The deionized water producing system of the present invention is used to produce deionized water necessary in many applications for cleaning and cleansing products and surfaces. In particular the present invention relates to a compact, easily transportable method and apparatus for cleaning surfaces of vehicles, boats, buildings etc., although it is to be appreciated that the claimed invention could be used in most any commercial, residential or industrial process where deionized water is needed. The apparatus and method described below provides a sequence of particular components, specifically a sediment filtration device to initially remove sediment particles from the water introduced into the system, a carbon adsorption filtration device for removing certain chemicals and organic materials from the water, a first ion exchange tank and a second ion exchange tank including a mixed bed of resins. From the second ion exchange tank the now deionized water is directed to a nozzle to be dispensed or a holding tank to be dispensed or used at a desired later time.

### DESCRIPTION OF THE DRAWING

The invention will now be described, by way of example, with reference to the accompanying drawing in which:

FIG. 1 is a diagrammatic view of the water treatment process using the apparatus of the current invention;

FIG. 2 is a general flow diagram of the described water deionization process described herein;

FIG. 3 is a flow diagram of the cation resin bed regeneration process;

FIG. 4 is a flow diagram of the mixed anion resin bed regeneration process; and

FIG. 5 is a table of certain acids and bases and their relative dissociation constants.

### DESCRIPTION OF THE PREFERRED EMBODIMENTS

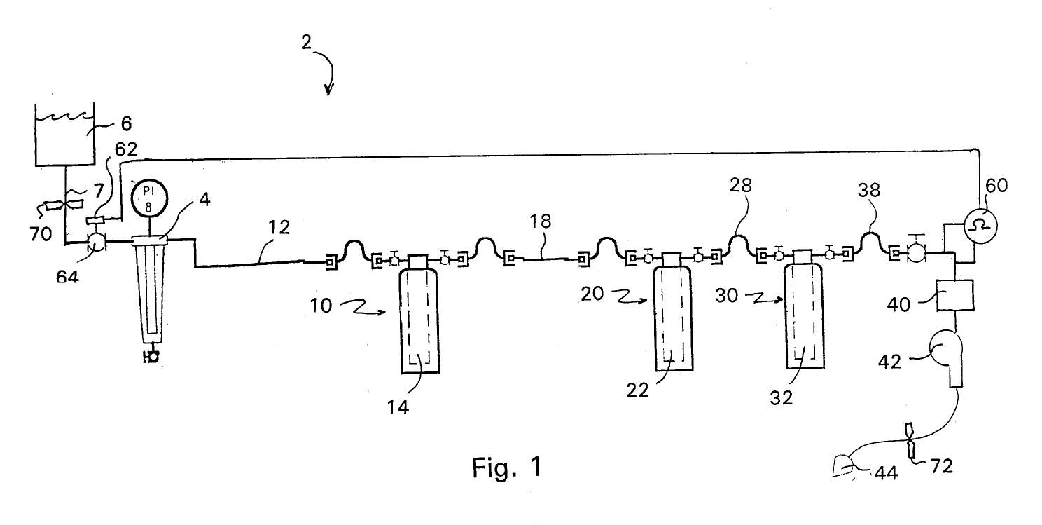

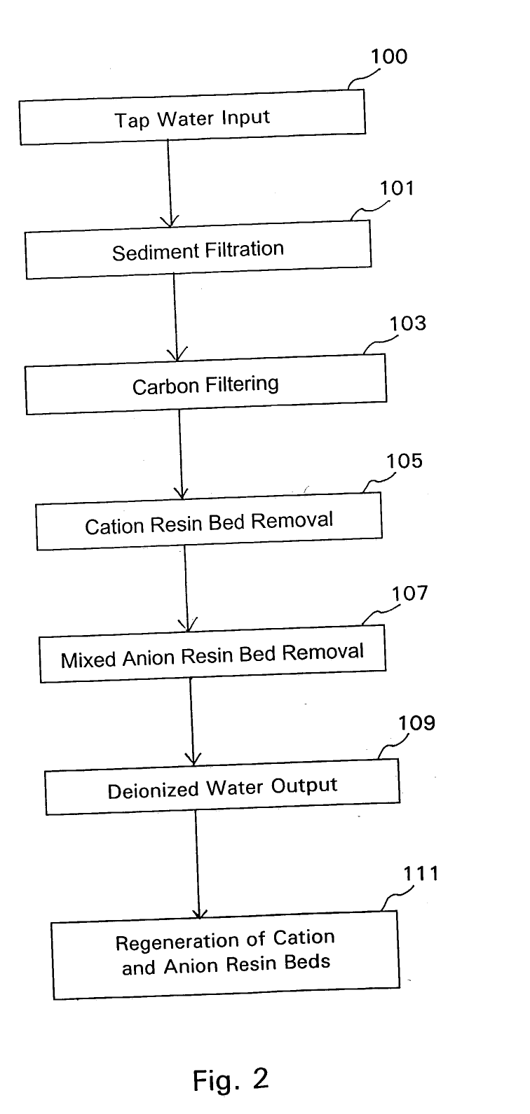

Observing FIGS. 1 and 2, the present deionized water producing system 2 is now described generally. The system 2 includes a number of particular components, specifically a sediment filtration device 4 to initially remove sediment particles from the water introduced into the system, a carbon adsorption filtration device 10 for removing certain chemicals and organic materials from the water, a first ion exchange tank 20 and a second ion exchange tank 30. From the second ion exchange tank 30 the deionized water is directed to a nozzle 44 to be dispensed, or a holding tank 40 to be dispensed or used at a desired later time. A further description of these elements and their respective functions is provided below.

As shown in FIG. 2, and with reference to FIG. 1, source water is generally input at step 100 to the present system from a city or local water source 6. This tap or city water often contains dissolved organic and inorganic materials. These materials when dissolved, separate into positive and negative components and ions. When water containing these ions evaporates as the washed surface air-dries, these ions or dissolved organic and inorganic materials remain on the washed surface causing visible spotting. Typical ions normally found in city water can include cations, for example: sodium, calcium, magnesium, potassium iron and manganese. Anions may include: chlorides, sulfates, nitrates, carbonates and silicates.

As the tap water enters the system 2 through an input conduit 7, it first encounters the sediment filtration device 4 at step 101. The filtration device 4 is preferably a carbon filter 5 that is sized to allow for a flow rate of around 1 gpm of water per square foot surface area of carbon. The purpose of the filter 5 is for the removal of any macro-molecules that might be present in the tap water stream. Removal of macro-molecular sediment extends the effective life of the rest of the water treatment system 2. The sediment filtration device 4 and function is important because failure to remove sediment from the water flowing through the subsequent system causes excessive pressure drop through the carbon adsorption device 10 and can lead to clogging of spray nozzles and valves in the system.

To filter sediment from tap water, the sediment filtration device is provided with a filter media consisting of an adsorptive matrix of spun polypropylene which uses the adsorptive process, rather than sieving, which traps particles in the matrix of the filter media. Because different water sources can contain substantially different sizes and amount of sediment, the present sediment filter consists of graded depth filters having a range of around 5 to 20 microns. These adsorptive filters do not rely on sieving, however other types of sediment filter media may alternatively be used. For example cartridges which rely on sieving, which merely provide pores of slightly smaller size than the sediment particles being removed from the water, could be used in place of the adsorptive matrix type. As all of these filter types are readily available in the industry and can be obtained from numerous manufacturers, no further description is believed necessary.

From the sediment filter device 4 the water is output via a second conduit 12 certain chemicals and organic materials from the water. The carbon adsorption filtration device 10 is provided with a carbon bed 14 containing acid washed activated carbon to remove at least chlorine, chloramines, and organic material. The chlorine and chloramines (chlorine with ammonia added) typically found in a city water source, break down the subsequent resin beds 22, 32 thus limiting the life of these expensive resin beads 23, 33, 35 contained in the following tanks. Furthermore, chlorine also oxidizes minerals changing them from dissolved to solid particles that cause fouling of the resins and resin beds. Activated carbon is effective in removing these oxidizing chemicals thus prolonging the life of the following deionizing resins which are to be discussed in greater detail below.

This activated carbon filter 14 contains acid washed activated carbon which is a sorbent used to remove a variety of organic chemicals from the water. As the water to be purified flows over the surface of and between the carbon molecules in the carbon bed 14, solutes diffuse from the water stream into the pores of the individual carbon molecules and subsequently become adsorbed, or attached, to the surface of the pore. In this way organic materials are pulled out of the water stream. In addition, the activated carbon removes organic matter which tends to occur as large molecules that use excessive capacity in the resin beds by blinding the ion exchange sites.

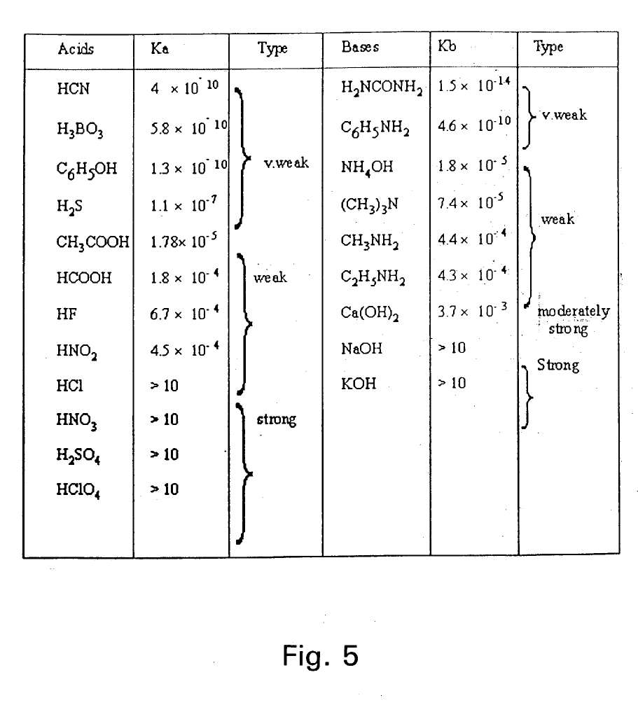

Following the activated carbon bed 10, the water is input via a third conduit 18 into the first resin tank 20 at step 105. Deionization is the process of removing ionizable solids from water using principles of ion exchange. The first resin tank 20 contains strong acid cation (SAC) resin which is a high capacity, gelular, sulfonated, polystyrene resin supplied in hydrogen form. Strong acids, like strong bases are understood in the art to dissociate in a solution almost completely. An acid or base having a dissociation constant Kₐ, K_{b} respectively, greater than 10 are considered to be strong. By way of example, a table of certain acids and bases and their relative dissociation constants is provided in FIG. 5. This cation resin has exchange sites which exchange hydrogen (H⁺) ions for other positively charged ions in the water supply. For example, it exchanges (H⁺) for calcium, magnesium, iron and manganese all of which cause spotting or staining in rinse waters.

The first resin tank 20 of the ion exchange process contains the strong acid cation resin made of polystyrene beads. This strong acid cation resin in the hydrogen form is a high capacity, gelular, sulfonated resin. The beads 23 making up the bed 22 of the strong acid cation resin have a 8% divinylbenzene cross-linking for superior physical strength. An exemplary product in CG8-H, CG8-H—NG, CG8-H—SC made by Resintech, Inc., a sulfonated copolymer of styrene and divinylbenzene in the hydrogen form and water.

The first ion exchange tank 20 containing the bed of strong acid cation resin 22 preferably has a capacity which substantially depends upon the characteristics of the source water. In a preferred embodiment the first ion exchange tank containing the bed of strong acid cation resin has a flow rate capacity of the between about 1-3 gpm although higher flow rates are also possible.

As water passes down through the strong cation bed 22, it encounters the resin beads 23, each of which contains a large number of negatively charged exchange sites in the pores and microscopic paths of the structure. As the positively charged calcium, magnesium, iron and manganese cations in the water contact the beads, they are attracted to the negative exchange sites. Since the noted cations in the water are stronger than the positive hydrogen ions, they drive off the hydrogen ions (H⁺) and attach to the negative charged exchange sites. The displaced hydrogen ions (H⁺) pass through the strong acid cation resin bed and are discharged from the first resin tank.

Upon being output from the first resin tank 20, the water is free of spotting and staining constituents as discussed above. However at this point the water is very acidic due to the large population of displaced (H⁺) ions. In order to neutralize the water a second resin tank 30 is provided containing anion resins, which specifically exchange OH− ions for other negatively charged ions like chloride, sulfates, and alkalines. The water is input via a fourth conduit 28 to the second resin tank 30 at step 107. Anion resins provided therein have exchange sites which add a rich mixture of OH− ions to water that has an excess of (H⁺) ions. The end result of which, as is well known in the art, is HOH or H₂O and deionized water that is free of any dissolved organics or inorganics and is completely free of positively charged (H⁺) ions.

The second tank 30 has preferably a mixed anion bed 32 containing both strong base anion resin beads 33 and weak base anion resin beads 35. Weak bases, and acids, are generally understood as those with dissociation constants of between about 10⁻⁴ to 10^{-7.} Again, certain bases and acids and their relative dissociation constants are shown in the table in FIG. 5. The resin beads 33, 35 themselves are made of polystyrene. The strong base anion resin beads 33 are supplied in the hydroxide form and are a gelular, Type 1 anion exchange resin as is known in the art. An exemplary product is SBG1-OH, SBG1-OH (NG), SBG1-OH (SC), made by Resintech, Inc., specifically, trimethylamine functionalized chloromethylated copolymer of Styrene and divinylbenzene in the hydroxide form, and water. The weak base anion resin beads are a macroporous anion exchange resin with quarternary and tertiary amine groups. An exemplary product is WBMP, WBMP-HP, WBMP-FB, WBMP-OH, made by Resintech, Inc., specifically, dimethylamine functionalized chloromethylated copolymer of styrene and divinylbenzene in the hydroxide form, and water. The bed of mixed strong base anion resin and weak base anion resin preferably has a capacity of between about 1-3 gal. per min. dependent again upon water quality.

The strong base anion resin is highly ionized and can be used over the entire pH range to remove mineral acids. The weak base anion resin has the ability to reversibly exchange large molecular weight organics and are generally higher in acid-removing capacity than strong base anion resins because of their adsorption ability. Also, the weak base anion resin removes negatively charged ions but not carbon dioxide or silica. It is known that carbon dioxide has no spotting or staining characteristics and silica can leave a deposit on some metal surfaces like aluminum and copper. Carbon dioxide can exist up to 100 ppm in water while silica generally exists in concentrations of less than 10 ppm and the weak base anion resin has a 40% more capacity than the strong base anion resin. Given these, the ratio of weak base anion resin to strong base anion resin is preferably between about 75:25 by volume and more preferably about 73:27. This mixture of strong and weak base anion resins results in about a 30% gain in capacity over straight strong base anion resin.

In general, as the highly acidic water passes down through the mixed anion bed 32, it encounters the mixed strong anion base resin beads 33 and weak anion base resin beads 35, each of which contains a large number of negatively charged exchange sites in the pores and microscopic paths of the structure. As the negatively charged chloride, sulfate alkaline ions in the water contact the different strong basic anion resin beads, they are attracted to the negative exchange sites which then elute off the hydroxyl radicals (OH−). When these radicals are released from the resins they react with the (H⁺) anions in solution and convert to pure water.

The deionized processed water is output via conduit 38 at step 109 now ready for use or storage. According to an embodiment of the present invention a deionized water storage tank 40 can store the water for substantially immediate or later use with a pump 42 and spray nozzle 44, or the deionized water can be supplied directly to the pump 42 and spray nozzle 44 for immediate use in cleaning an object. The pump 42 supplies the spray nozzle 44 with the deionized water at a particular pressure range of between 800 and 1,400 psi, and more preferably about 1,100 psi. A particular pump geared to supply such a desired pressure is incorporated into the system and the motor for driving the pump may be any such pump motor as is known in the art.

The resin tanks, or vessels 20 and 30 are in general sized with the flow rate to provide a certain contact time of water with the media in the tanks. For typical residential and even commercial uses flow rates can be in the range of anywhere from less than 1 gpm to at least 6 gpm. In the present invention for flow rates of between about 1-3 gpm, tanks can be sized from a tank of about 20 inches in length and 4 inches in diameter and holding about 0.25 cu. ft. of media beads to tanks of 44 inches in length holding about 1.4 cu. ft of media and most preferably about 33 inches in length by 4 inches in diameter having about 0.75 cu. ft. of media.

The spray nozzles are another important aspect of the present invention.

Because of the substantially lower water usage of the above described apparatus and method it is important that the spray nozzles provide a consistent and uniform spray pattern of the deionized water from the spray tip. The spray dispensed from the spray tip is usually ejected within a spray pattern range of about 10°-30°, and more preferably within about 15°-25°. The particular spray tips to provide such a spray pattern range are generally fabricated from hardened stainless steel for maximum wear life and good corrosion resistance and have an orifice designed to impart an even flat spray pattern with uniform spray distribution across the pattern area. The orifice of the spray tips is sized to permit a specific flow of between about 0.5 to 6 gal. per min. and more preferably about 2 or 3 gal. per min.

The deionized water which is stored in tank 40 and ejected from nozzle 44 and used to clean the desired objects can be monitored for a desired water quality by measuring the resistivity (ohms) of the water. Specifically, deionized water from the above described system when the media is completely regenerated, i.e., the media is essentially new, will measure a resistivity of about 500,000 ohms. When the media has been used up and the resin media beads need to be regenerated, this resistivity measurement will fall to about 10,000 ohms. In general the media will maintain the condition of around 500,000 ohms for the useful life of the media before regeneration is necessary. It is important to ensure that the resistivity of the water is substantially maintained at least above the 10,000 ohms, if not the media is not only incapable of absorbing sufficient cations from the water, but may also not be able to neutralize the abundance of H+ ions in the water from the bed of strong acid cation resin beads. This is critical especially in the understanding that where there is an overabundance of displaced H+ ions in the water from the cation bed 22, and there are an insufficient OH− ions left in the mixed anion resin bed, an overly acidic deionized water will be produced which, as discussed previously can damage the objects being washed with the deionized water.

In an embodiment of the present invention, an ohmmeter 60 is provided after the mixed bed of anion resin beads 32 in the system 2 to measure the resistivity of the deionized water after passing through the system 2. The ohmmeter 60 may be connected to a solenoid 62 for closing a shut off valve 64 in the system when a desired limit is reached, for example, 10,000 ohms. This may prevent use of the system where such ineffective or even damaging water is being produced.

In another embodiment of the present invention restriction plates may be used in the system to ensure that the desired flow rate of about 1-3 gal. per min. is passed through the system and the tanks containing the resin bead media. An initial restriction plate 70 may be placed in the system before the sediment filtration device 4. The restriction plate can be a baffle or orifice which provides a desired flow rate therethrough independent upon the flow rate and pressure delivered by the water source i.e., the city water supply. In the presently described system a plate in the form of a washer is provided in the input conduit 7 having a hole of between about ¼ and 1/16th of an inch in diameter and preferably about ⅛th inch in diameter. In general from a city water supply this size restricts the flow rate for the system to about 1-3 gal. per min. to flow through the system 2. Such restrictions are important in that where such restrictions are not undertaken a overly high flow rate through the tanks may not allow enough contact time between the resin beads and the water to accomplish the deionization. This can also lead to channeling of the water through the resin beds further reducing the area of media with which the water can come into contact with.

Also, a second restriction plate 72 may be provided in, or adjacent, the nozzle 44, to ensure that a similar desired flow rate is output from the nozzle, especially in the case where the holding tank 40 contains a substantial amount of deionized water. The second restriction plate should be generally the same size as the initial restriction plate, i.e., have about the same size hole in the range of about ¼-1/16th of an inch.

As with current ion exchange resins the resins of the current invention have a finite number of exchange sites. After a certain amount of usage depending upon the quality of the source water, these exchange sites are depleted, thus requiring a regeneration of the resin. In the current process, regeneration generally means removing the resin beads from the resin tanks, restoring their cationic and anion properties for deionizing the water, and returning the resin beds to the tanks to the standards as will be explained in further detail below.

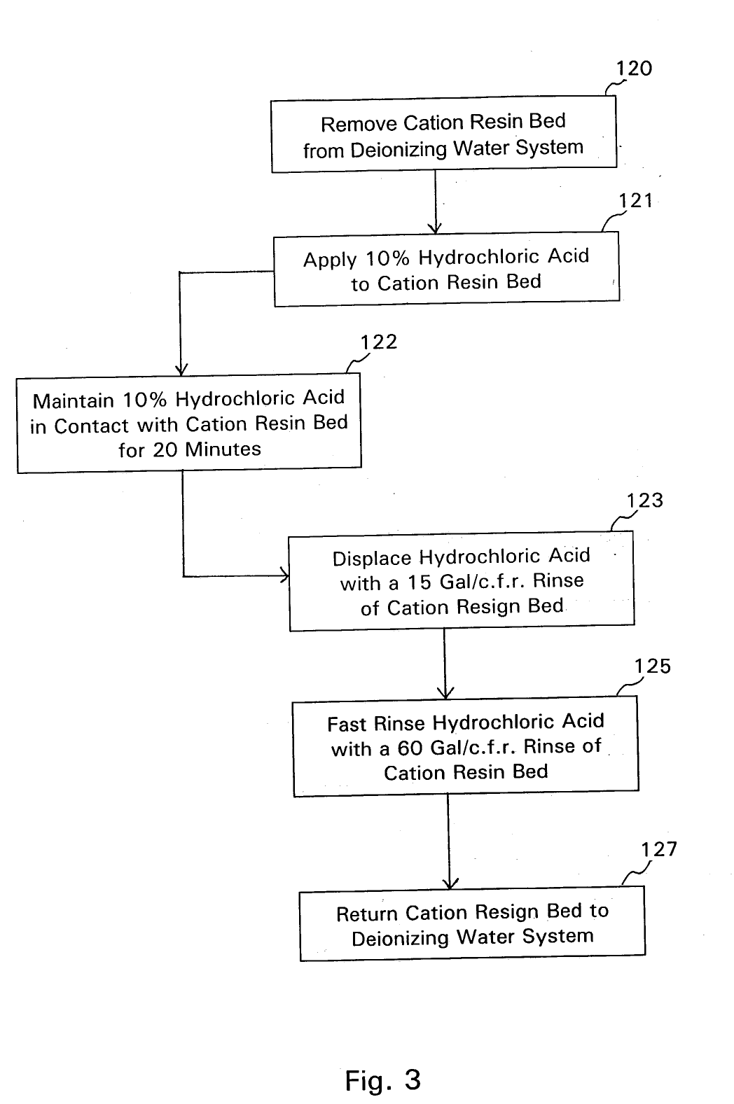

As the cation and anion resins become exhausted, meaning when they have exchanged all the H+ and OH− ions they have, the resins are in need of regeneration in step 111. Turning to FIG. 3, cation exchange resins according to the method are taken out of the system 2 at step 120, and at step 121 are contacted by approximately a 10% hydrochloric acid solution. As the hydrochloric acid solution passes down through the resin bed the positively charged hydrogen cations in the hydrochloric acid force off the positively charged cations that were attracted and held during the deionizing process as described above. The positive hydrogen ion attach to the negative exchange sites on the beads, restoring the resin to its regenerated hydrogen form.

This 10% hydrochloric acid solution needs to be at a temperature of around 70° F. In the cation resin regeneration process, 10 lb. of 10% hydrochloric acid per cubic foot of resin needs to come in contact with the resin for a time of about 20 minutes as shown at step 122. After this contact, the acid is displaced at step 123 with a rinse of deionized water at a volume of about 15 gallons per cubic foot of resin. The resin will next be fast rinsed at step 125 with 60 gallons of deionized water per cubic foot of resin and finally the regenerated resin beads are returned to the system at step 127.

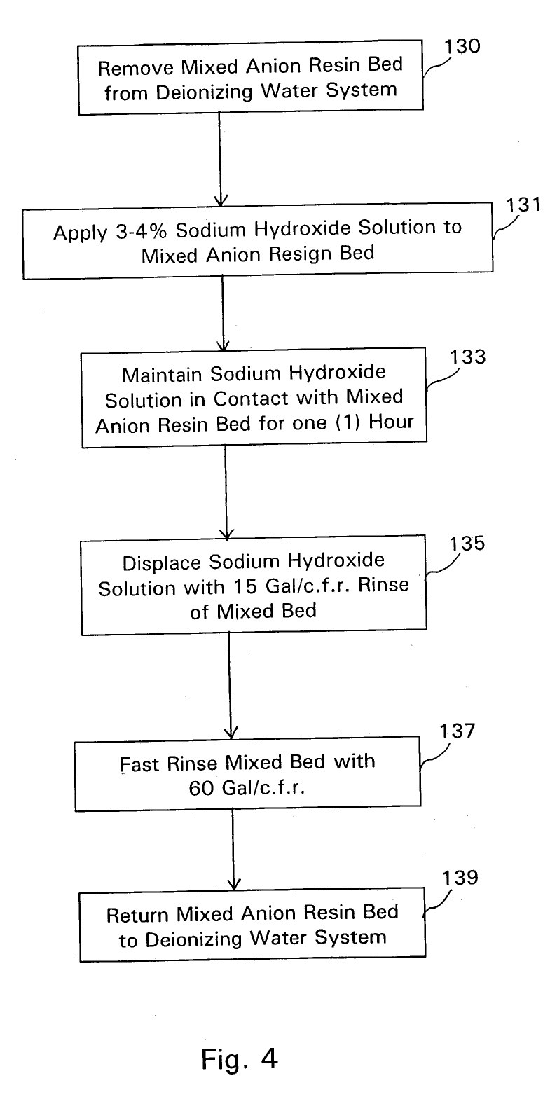

Observing FIG. 4, the mixed bed anion exchange resins are regenerated using a sodium hydroxide solution. At step 130 the mixed resins are removed from the system and at step 131 the sodium hydroxide solution is applied to the mixed resin bed. In the strong base resin, the sodium hydroxide solution passes down through the resin bed and exchanges with the mineral acids attracted and held by the beads during the process as described above, restoring the resin to its original form. On the other hand, with the weak base resin, the sodium hydroxide solution regenerates the resin by a process of acid neutralization.

Regeneration of the anion exchange resin includes maintaining about a 3-4% sodium hydroxide solution and water at 104° F.±2° F. at step 133. Brine is squeezed with saturated brine for 15 minutes, then the 3-4% sodium hydroxide solution is put into contact with the resin. That is about 10 lbs. of 3-4% sodium hydroxide per cubic foot of resin is allowed to contact the resin for 60 minutes. A displacement rinse of 15 gallons of deionized water per cubic foot of resin at step 135 is passed through the anion tank after which a fast rinse of 60 gallons of deionized water per cubic foot of resin is passed through the tank at step 137.

After the cation and anion beds have been regenerated according to the described method, the same resins are now ready for reuse in the deionization process at step 139. It is important to note that the same resins which are taken from the system and regenerated, are returned and reused in the system 2. Thus, the same media is continuously reused in the same process. This provides consistent and reproducable results, i.e., consistent water deionization, throughout the life of the media including numerous regeneration processes.

Since certain changes may be made in the above described improved apparatus and process for deionizing water, without departing from the spirit and scope of the invention herein involved, it is intended that all of the subject matter of the above description or shown in the accompanying drawings shall be interpreted merely as examples illustrating the inventive concept herein and shall not be construed as limiting the invention.

1. A water filtration and deionization process comprising the steps of:
filtering water to be treated through a sediment filtration device;
directing the water through an activated carbon bed;
conducting the water to be treated through a strong acid cation resin bed; and
directing the water to be treated through a mixed bed composed solely of a strong anion base resin and a weak anion base resin.

2. The water filtration and deionization process of claim 1 further comprising the step of regenerating an exhausted strong acid cation bed by maintaining a 10% hydrochloric acid solution in contact with the strong acid catior resin for a period of about 20 minutes, rinsing the 10% hydrochloric acid solution fron the strong acid cation resin with a displacement rinse volume of 15 gallons of deionized water per cubic foot of strong acid cation resin; and fast rinsing the strong acid cation resin with about 60 gallons of deionized water per cubic foot of strong acid cation resin.

3. The water filtration and deionization process of claim 1 further comprising the step of regenerating an exhausted nixed bed strong anion base resin and weak anion base resin by maintaining about 3%-4% sodium hydroxide solution with the mixed bed resins for approximately one hour; and rinsing the 3%-4% sodium hydroxide solution from the mixed bed resins with a displacement rinse volume of about 15 gallons of deionized water per cubic foot of imixed bed resins, and fast rinsing the mixed bed resins with about 60 gallons of deionized water per cubic foot of mixed bed resins.

4. A water filtration and deionization apparatus comprising:
a water source connected to a carbon bed sediment filter;
an acid washed activated carbon bed connected to the sediment filter;
a first tank containing a strong acid cation resin connected with the activated carbon bed;
a second tank containing a mixed bed composed solely of a strong base anion resin and a weak base anion resin connected with the first tank, the mixed bed contains a ratio of 75% weak base anion resin to 25% strong base anion resin; and
wherein the deionized water flows from the second tank to an output for one of storing and dispensing the deionized water for use.

5. The water filtration and deionization apparatus of claim 4 wherein the sediment filter is a cartridge filter sized to allow a maximum flow rate of about 1 gallon per minute per square foot of surface area of carbon

6. The water filtration and deionization apparatus of claim 4, wherein the strong acid cation resin is a high capacity, gelular, sulfonated, polystyrene resin in a hydrogen form.

7. The water filtration and deionization apparatus of claim 6, wherein the strong acid cation resin has 8% divinylbenzene cross-linking for superior physical strength.

8. The water filtration and deionization apparatus of claim 4, wherein the strong base anion resin is a gelular, type One resin in the hydroxide form.

9. The water filtration and deionization apparatus of claim 4, wherein the weak base anion resin is a macroporous resin with a plurality of quarternary and tertiary amine groups.

10. (CANCELED)

11. A method of deionizing water, the method comprising the steps of:
supplying water from a desired source through a sediment filter;
providing a bed of cation resin beads having negatively charged exchange sites;
passing water from the sediment filter through the bed of cation resin beads to remove desired cations in the water,
providing a bed of anion resin beads having positively charged exchange sites;
passing the water through the bed of anion resin beads to neutralize any acidity in the water;
providing the bed of anion resin beads as a mixed bed composed solely of strong base and weak base anion resin beads: and
providing in the mixed bed a ratio of strong base and weak base anion resin beads of about 75% weak base and 25% strong base anion resin beads.

12. (CANCELED)

13. (CANCELED)

14. The method of deionizing water as set forth in claim 11 further comprising the step of passing the water through a carbon adsorption filter device after the sediment filter and prior to passing the water through the beds of cation and anion resin beads.

15. The method of deionizing water as set forth in claim 14 further comprising the step of regenerating the mixed bed of strong base and weak base anion resin beads together by applying sodium hydroxide to restore anion exchange sites in both the strong base and weak base anion resin beads.

16. The method of deionizing water as set forth in claim 15 wherein during the step of regeneration applying to the mixed bed of strong base and weak base anion resin beads about 10 lbs. of approximately 3% to 4% sodium hydroxide per cubic foot of resin beads.

17. The method of deionizing water as set forth in claim 15 wherein during the step of regeneration the cation resin beads are restored by application of about 10 lbs. of approximately 10% hydrochloric acid solution per cubic foot of cation resin beads.
